(19) United States
(12) Patent Application Publication
(10) Pub. No.: US 2023/0165410 A1
(43) Pub. Date: Jun. 1, 2023

(54) Hair Collection Device

(71) Applicant: Anna Dengel, Necedah, WI (US)

(72) Inventor: Anna Dengel, Necedah, WI (US)

(21) Appl. No.: 18/059,513

(22) Filed: Nov. 29, 2022

Related U.S. Application Data
(60) Provisional application No. 63/283,911, filed on Nov. 29, 2021.

(51) Int. Cl. A47K 3/28; A46B 9/02; A46D 1/00; A46B 15/00; B08B 1/00; A45D 44/16

(52) U.S. Cl. CPC A47K 3/281; A46B 9/026; A46D 1/0207; A46B 15/0085; B08B 1/002; A45D 44/16; A46B 2200/1013; A46B 2200/01

(57) ABSTRACT

The present invention relates to a novel hair collection device. The hair collection device is a device for collecting unwanted hair when washing and rinsing hair in the shower. The device comprises a collection member that is box shaped with a suction cup positioned on its rear surface to allow the device to stick to the wall of the bath or shower. The device comprises an opening on its front surface to allow access to the interior cavity. The interior cavity comprises a plurality of silicone spikes that grab onto hair and retain it inside the device.

### CROSS-REFERENCE TO RELATED APPLICATION

The present application claims priority to, and the benefit of, U.S. Provisional Application No. 63/283,911, which was filed on Nov. 29, 2021, and is incorporated herein by reference in its entirety.

### FIELD OF THE INVENTION

The present invention relates generally to the field of hair collection devices. More specifically, the present invention relates to an improved hair collection device that provides users with a device for collecting unwanted hair when washing and rinsing in the shower. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in hair collection devices. Generally, when washing and conditioning hair in the shower, excess hair can fall into the drain and cause clogs. Thus, unwanted hair in the shower can be unsightly, especially, in households with multiple people. Further, trying to unclog shower drains can be frustrating and expensive.

Daily hair loss is considered normal and occurs naturally as part of the growing process. This shedding is completely natural but does lead to challenges particularly for those women that have long hair. One of the most common places that women shed hair is in the shower. This occurs in part, due to hygiene practices such as, but not limited to, shampooing of the hair. During this process, hair strand shedding can be exacerbated due to the stress of washing the hair. As the hair strands are shed, they will accumulate in the bottom of the shower and often be directed by the flow of water toward the drain. Over a short period of time, this can result in poor drain performance precipitating the requirement for plumbing repairs and/or maintenance.

Most individuals will attempt to collect the hair during the act of other activities, such as cleaning the shower or bath. While this helps alleviate the aforementioned plumbing problems, it is more desirable to collect the hair on a more frequent basis. Some individuals will collect the shed hair strands during the bathing process but often find that maintaining the collection of hair in an organized manner for subsequent disposal is difficult. Bathroom shower and tub surfaces are often tile or other materials and as such, any collected hair can easily be removed by splashing water. Attempts are often made to place collected hair on a ledge or similar item but again, these surfaces do not provide effective retention of the collected hair.

Accordingly, there is a need for a hair collection device that is releasably secured to a shower or bathtub wall, wherein the hair collection device includes a hair collection member that is configured to provide retention of collected hair strands for subsequent disposal thereof.

Therefore, there exists a long-felt need in the art for a hair collection device that provides users with a device for collecting unwanted hair when washing and rinsing in the shower. There is also a long-felt need in the art for a hair collection device that features a suction cup on the back of the device that enables it to be stuck to the shower wall and maintain easy access to the front spikes for collecting hair. Further, there is a long-felt need in the art for a hair collection device that includes silicone spikes inside the front of the device that can grab loose hair from the fingers and retain it inside, preventing the hair from clogging the drain. Moreover, there is a long-felt need in the art for a device that reduces stray hair in the shower, offering a more sanitary and cleaner environment. Further, there is a long-felt need in the art for a hair collection device that includes numerous different sizes and styles to accommodate any user. Finally, there is a long-felt need in the art for a hair collection device that is decorative and effective at collecting unwanted hair when washing in a shower.

The subject matter disclosed and claimed herein, in one embodiment thereof, comprises a hair collection device. The hair collection device is a device for collecting unwanted hair when washing and rinsing hair in the shower. The device comprises a collection member that is box shaped and measures approximately 3 inches by 3 inches by 3 inches. The device further comprises a suction cup positioned on its rear surface to allow the device to stick to the wall of the bath or shower. The device comprises an opening on its front surface to allow access to the interior cavity. The interior cavity comprises a plurality of silicone spikes that grab onto hair and retain it inside the device. In use during a shower or bath, the user would take the loose hair that accumulates on their fingers after washing and/or conditioning their hair and insert it into the opening and onto the plurality of silicone spikes. The spikes retain the hair and prevent it from clogging the shower drain. After their shower or bath, a user can then empty the device.

In this manner, the hair collection device of the present invention accomplishes all of the foregoing objectives and provides users with a device that collects unwanted hair when in a shower or bath. The device reduces hair accumulation in a shower/bath drain and prevents clogging. The device can be manufactured in multiple designs and styles based on a user's preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hair collection device. The hair collection device is a device for collecting unwanted hair when washing and rinsing hair in the shower. The device comprises a collection member that is box shaped. The device further comprises a suction cup positioned on its rear surface to allow the device to stick to the wall of the bath or shower. The device comprises an opening on its front surface to allow access to the interior cavity. The interior cavity comprises a plurality of silicone spikes that grab onto hair and retain it inside the device.

Generally, the hair collection device comprises a collection member designed for being selectively coupled to a wall of the shower or bath. The collection member is designed for receiving the hair from the hand of the user to allow the user to collect the hair when the hand of the user is wiped across the interior of the collection member.

In one embodiment, the collection member is box-like in configuration and measures approximately 3 inches by 3 inches by 3 inches. The collection member includes a front surface, a rear surface, two opposing side surfaces, a top surface and a bottom surface. The collection member is configured to be releasably secured to a shower or bathtub wall. While the collection member is illustrated herein as being box-like in configuration, it is further contemplated within the scope of the present invention that the collection member could be provided in alternate shapes and sizes. Furthermore, it should be understood within the scope of the present invention that the collection member could be provided in numerous different colors, styles, and patterns based on a user's needs and/or wants. The forming of all or a portion of the hair collection device into various shapes, sizes, colors, styles, and patterns provides users options, so as to match existing décor in the bathroom of the user.

In one embodiment, the collection member is configured as two separate pieces which can be secured together for use via a press fit or snap fit configuration, or via spring clips or other locking features. In another embodiment, the collection member is configured as one integral piece with a larger opening to access the interior cavity.

In one embodiment, the collection member is configured in a box-like configuration with an open, interior cavity. The open, interior cavity comprises a plurality of spike-like projections. Any suitable number of spike-like projections can be utilized as is known in the art. Further, any suitable shape and size can be utilized for the spike-like projections, as long as they are configured to receive hair from the fingers of the user. The spike-like projections are secured within the interior cavity via any suitable securing means as is known in the art. Typically, the spike-like projections are manufactured of silicone, but can be manufactured of any suitable material as is known in the art that retains hair. Thus, the plurality of spike-like projections are designed for engaging unwanted hair on the hand of the user and facilitating removal of the hair from the hand of the user, when the hand of the user is wiped across the plurality of spike-like projections.

In one embodiment, the front surface of the collection member comprises an opening for accessing the plurality of spike-like projections. The opening can be any suitable shape and size as is known in the art, as long as the opening allows a user to access the spike-like projections.

In one embodiment, at least one mounting member is coupled to the rear surface of the collection member. The mounting member is designed for selectively engaging the wall of the shower or bath to secure the collection member to the wall. Typically, the mounting member comprises a suction cup or a plurality of suction cups. The suction cup is coupled to the collection member via any suitable securing means as is known in the art. The suction cup is designed for creating a vacuum against the wall to secure the suction cup and the collection member to the wall. Typically, the suction cup is about 1 inch in diameter.

In use, the user takes the collection member and pushes it against the wall to compress the suction cup against the wall to allow the suction cup to create a vacuum against the wall and secure the collection member to the wall. The user then places their hand within the opening so that the plurality of spike-like projections slide between the fingers of the hand. The plurality of spike-like projections engage the hair and remove the hair from the hand of the user. Once the user has completed their shower, the hair collected within the receiving member is pulled out of the collection member and thrown away to prevent the hair from being rinsed down the drain and possibly clogging the drain.

In one embodiment, the hair collection device is disposable. In operation the user will mount the base member in a desired location on the shower or bathtub wall utilizing the provided suction cup. A user then manually collects shed hair strands in the shower and/or bathtub and places the collected hair strands within the opening of the hair collection member. The engagement with the plurality of spike-like projections provides effective retention of the collected hair strands. After ensuing collection of a desired quantity of shed hair strands, the hair collection device is removed and disposed of properly. A second hair collection device is then secured to the wall for use. In another embodiment, the hair collection device can be reusable. Once the desired quantity of shed hair strands is collected, a user empties the interior cavity by reaching in through the opening and removing the hair and disposing of it. In yet another embodiment, the collection member can be separated into two pieces, allowing a user to clean out the acquired hair. Once clean, the two pieces are secured back together and the hair collection device is then re-attached to the shower/bath wall.

Generally, the hair collection device is manufactured of a semi-rigid material, such as, but not limited to, plastic or other synthetic materials, such as rubber, polycarbonate, polyethylene, ABS, PVC, etc., or any other suitable materials as is known in the art.

In yet another embodiment, the hair collection device comprises a plurality of indicia.

In yet another embodiment, a method of collecting unwanted hair while washing in the shower or bath is disclosed. The method includes the steps of providing a hair collection device comprising a collection member with a suction cup positioned on the rear surface and an opening positioned on the front surface for accessing the plurality of silicone spikes. The method also comprises securing the device via the suction cup to a shower or bath wall. Further, the method comprises, while showering or bathing, removing any unwanted hair from a user's fingers by inserting the unwanted hair into the opening and onto the plurality of silicone spikes. Finally, the method comprises emptying the device as needed after showering or bathing.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the hair collection device of the present invention showing the front surface of the device with silicone spikes in accordance with the disclosed architecture;

FIG. 2 illustrates a perspective view of one embodiment of the hair collection device of the present invention showing the rear surface of the device with a suction cup for mounting in accordance with the disclosed architecture;

FIG. 3 illustrates a perspective view of one embodiment of the hair collection device of the present invention in use in accordance with the disclosed architecture; and

FIG. 4 illustrates a flowchart showing the method of collecting unwanted hair while washing in the shower or bath in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hair collection device that provides users with a device for collecting unwanted hair when washing and rinsing in the shower. There is also a long-felt need in the art for a hair collection device that features a suction cup on the back of the device that enables it to be stuck to the shower wall and maintain easy access to the front spikes for collecting hair. Further, there is a long-felt need in the art for a hair collection device that includes silicone spikes inside the front of the device that can grab loose hair from the fingers and retain it inside, preventing the hair from clogging the drain. Moreover, there is a long-felt need in the art for a device that reduces stray hair in the shower, offering a more sanitary and cleaner environment. Further, there is a long-felt need in the art for a hair collection device that includes numerous different sizes and styles to accommodate any user. Finally, there is a long-felt need in the art for a hair collection device that is decorative and effective at collecting unwanted hair when washing in a shower.

The present invention, in one exemplary embodiment, is a novel hair collection device. The device comprises a collection member that is box shaped and measures approximately 3 inches by 3 inches by 3 inches. The device further comprises a suction cup positioned on its rear surface to allow the device to stick to the wall of the bath or shower. The device comprises an opening on its front surface to allow access to the interior cavity. The interior cavity comprises a plurality of silicone spikes that grab onto hair and retain it inside the device. The present invention also includes a novel method of collecting unwanted hair while washing in the shower or bath. The method includes the steps of providing a hair collection device comprising a collection member with a suction cup positioned on the rear surface and an opening positioned on the front surface for accessing the plurality of silicone spikes. The method also comprises securing the device via the suction cup to a shower or bath wall. Further, the method comprises, while showering or bathing, removing any unwanted hair from a user's fingers by inserting the unwanted hair into the opening and onto the plurality of silicone spikes. Finally, the method comprises emptying the device as needed after showering or bathing.

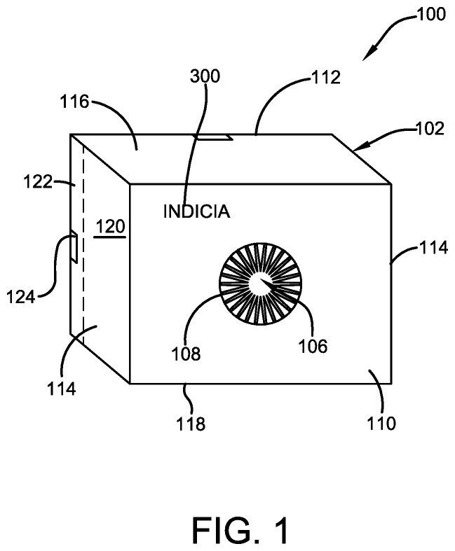

Referring initially to the drawings, FIG. 1 illustrates a perspective view of one embodiment of the hair collection device 100 of the present invention. In the present embodiment, the hair collection device 100 is an improved hair collection device 100 that is a device for collecting unwanted hair when washing and rinsing hair in the shower or bath. Specifically, the device 100 comprises a collection member 102 that can be adhered to a shower or bath wall. The collection member 102 comprises an opening 104 to allow access to the interior cavity 106. The interior cavity 106 comprises a plurality of silicone spikes 108 that grab onto hair and retain it inside the collection member 102.

Generally, the collection member 102 is designed for receiving the unwanted hair from the hand of the user to allow the user to collect the unwanted hair at a later time, to be thrown out when the hand of the user is wiped across the interior 106 of the collection member 102. Further, the collection member 102 of the hair collection device 100 is designed for being selectively coupled to a wall of a shower or bath, or any other suitable position within a bathroom.

Furthermore, the collection member 102 is box-like in configuration and measures approximately 3 inches by 3 inches by 3 inches, or any other suitable size as is known in the art. The collection member 102 includes a front surface 110, a rear surface 112, two opposing side surfaces 114, a top surface 116, and a bottom surface 118. The collection member 102 is configured to be releasably secured to a shower or bathtub wall. While the collection member 102 illustrated herein is box-like in configuration, it is further contemplated within the scope of the present invention that the collection member 102 could be provided in alternate shapes and sizes. Furthermore, it should be understood within the scope of the present invention that the collection member 102 could be provided in numerous different colors, styles, and patterns based on a user's needs and/or wants. Specifically, the forming of all or a portion of the hair collection device 100 into various shapes, sizes, colors, styles, and patterns provides users options, so as to match existing décor in the bathroom of the user.

Typically, the collection member 102 is configured as two separate pieces 120 and 122 which can be secured together for use via a press fit or snap fit configuration, or via spring clips 124 or any other suitable locking features as is known in the art, depending on the needs and/or wants of a user. Generally, the collection member 102 can be split into any suitable configuration of two separate pieces 120 and 122. For example, the front surface 110 and opposing side surfaces 114 can be separated from the rear surface 112, the top surface 116, and the bottom surface 118. Further, the front surface 110, opposing side surfaces 114, the top surface 116, and the bottom surface 118 can be separated from the rear surface 112. Additionally, the rear surface 112, the top surface 116, the bottom surface 118, and the opposing side surfaces 114 can be separated from the front surface 110, or any other configuration as is known in the art. In another embodiment, the collection member 102 is configured as one integral piece with a larger opening 104 to access the interior cavity 106.

Furthermore, the collection member 102 is configured in a box-like configuration with an open, interior cavity 106. The open, interior cavity 106 comprises a plurality of spike-like projections 108. Any suitable number of spike-like projections 108 can be utilized as is known in the art. Further, any suitable shape and size can be utilized for the spike-like projections 108, as long as they are configured to receive unwanted hair from the fingers of the user. The spike-like projections 108 are secured within the interior cavity 106 and around the opening 104 via any suitable securing means as is known in the art. In one embodiment, the spike-like projections 108 are configured in a gasket, which is then secured around the opening 104 of the collection member 102, such that the projections 108 radially point inward. Typically, the spike-like projections 108 are manufactured of silicone but can be manufactured of any suitable material as is known in the art that retains hair. For example, the spike-like projections 108 can be manufactured of rubber, polyurethane, neoprene, etc. Thus, the plurality of spike-like projections 108 are designed for engaging unwanted hair on the hand of the user and facilitating removal of the hair from the hand of the user when the hand of the user is wiped across the plurality of spike-like projections 108.

Additionally, the front surface 110 of the collection member 102 comprises an opening 104 for accessing the plurality of spike-like projections 108. The opening 104 can be any suitable shape and size as is known in the art, as long as the opening 104 allows a user to access the spike-like projections 108. Generally, there is only one opening 104 on the front surface 110, but any suitable number of openings 104 can be utilized as is known in the art, depending on the needs and/or wants of a user.

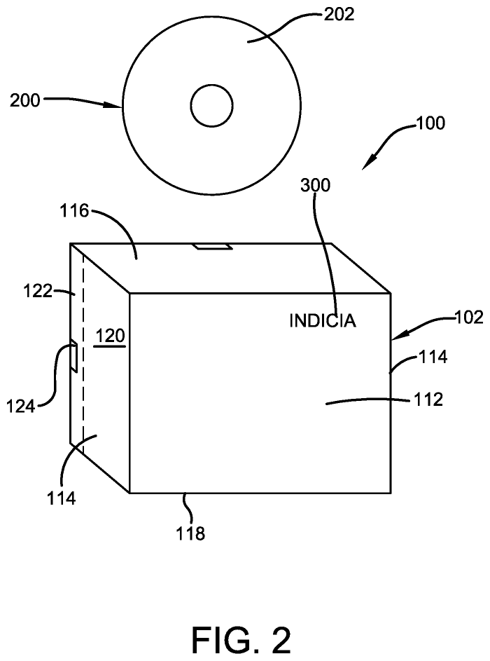

As shown in FIG. 2, at least one mounting member 200 is coupled to the rear surface 112 of the collection member 102. The mounting member 200 is designed for selectively engaging the wall of the shower or bath to secure the collection member 102 to the wall. Typically, the mounting member 200 comprises a suction cup 202, but any other suitable securing means can be utilized as is known in the art, depending on the needs and/or wants of a user. The suction cup 202 is coupled to the collection member 102 via any suitable securing means as is known in the art, such as adhesives, glues, etc. The suction cup 202 is designed for creating a vacuum against the wall to secure the suction cup 202 and the collection member 102 to the wall for use. Typically, the suction cup 202 is about 1 inch in diameter, but can be any suitable shape and size as is known in the art.

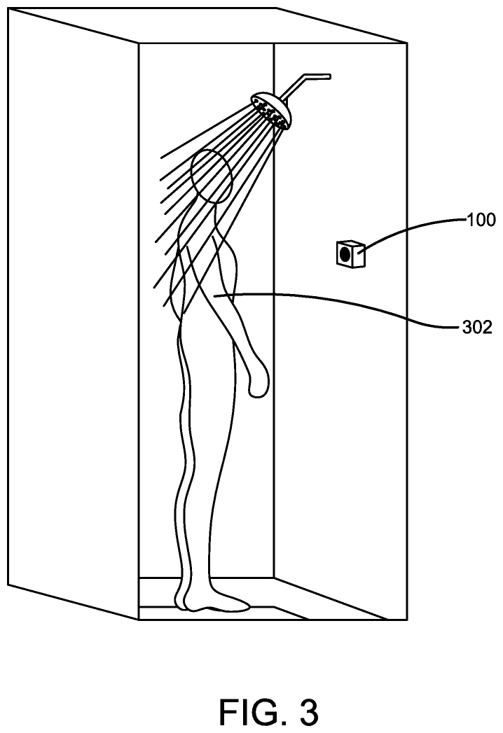

As shown in FIG. 3, in use, the user 302 takes the collection member 102 and pushes it against the wall to compress the suction cup 202 against the wall to allow the suction cup 202 to create a vacuum against the wall and secure the collection member 102 to the wall. The user 302 then places their hand within the opening 104 so that the plurality of spike-like projections 108 slide between the fingers of the user. The plurality of spike-like projections 108 engage the unwanted hair and remove the hair from the hand of the user 302. Once the user 302 has completed their shower, the hair collected within the collection member 102 is pulled out of the collection member 102 and thrown away to prevent the hair from being rinsed down the drain and possibly clogging the drain.

In one embodiment, the hair collection device 100 is disposable. In operation, the user 302 will mount the collection member 102 in a desired location on the shower or bathtub wall utilizing the provided suction cup 202. A user 302 then manually collects shed hair strands in the shower and/or bathtub and places the collected hair strands within the opening 104 of the collection member 102. The engagement with the plurality of spike-like projections 108 provides effective retention of the collected hair strands. After ensuing collection of a desired quantity of shed hair strands, the hair collection device 100 is removed and disposed of properly. A second hair collection device 100 is then secured to the wall for use. In another embodiment, the hair collection device 100 can be reusable. Once the desired quantity of shed hair strands is collected, a user 302 empties the interior cavity 106 by reaching in through the opening 104 and removing the hair and disposing of it. In yet another embodiment, the collection member 102 can be separated into two pieces 120 and 122, allowing a user 302 to clean out the acquired hair. Once clean, the two pieces 120 and 122 are secured back together and the hair collection device 100 is then re-attached to the shower/bath wall.

Generally, the hair collection device 100 is manufactured of a semi-rigid material, such as, but not limited to, plastic or other synthetic materials, such as rubber, polycarbonate, polyethylene, ABS, PVC, etc., or any other suitable materials as is known in the art.

In yet another embodiment, the hair collection device 100 comprises a plurality of indicia 300. The collection member 102 of the device 100 may include advertising, trademark, or other letters, designs, or characters, printed, painted, stamped, or integrated into the collection member 102, or any other indicia 300 as is known in the art. Specifically, any suitable indicia 300 as is known in the art can be included, such as, but not limited to, patterns, logos, emblems, images, symbols, designs, letters, words, characters, animals, advertisements, brands, etc., that may or may not be hair, bathroom, or brand related.

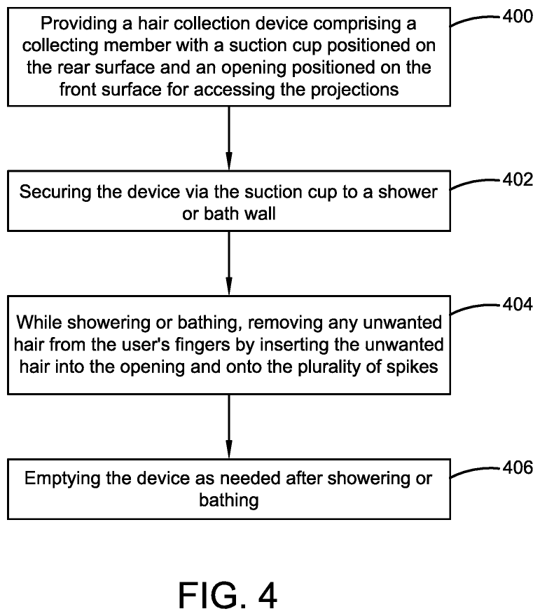

FIG. 4 illustrates a flowchart of the method of collecting unwanted hair while washing in the shower or bath. The method includes the steps of at 400, providing a hair collection device comprising a collection member with a suction cup positioned on the rear surface and an opening positioned on the front surface for accessing the plurality of silicone spikes. The method also comprises at 402, securing the device via the suction cup to a shower or bath wall. Further, the method comprises at 404, while showering or bathing, removing any unwanted hair from a user's fingers by inserting the unwanted hair into the opening and onto the plurality of silicone spikes. Finally, the method comprises at 406, emptying the device as needed after showering or bathing.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “hair collection device”, “collection device”, and “device” are interchangeable and refer to the hair collection device 100 of the present invention.

Notwithstanding the foregoing, the hair collection device 100 of the present invention can be of any suitable size and configuration as is known in the art without affecting the overall concept of the invention, provided that it accomplishes the above-stated objectives. One of ordinary skill in the art will appreciate that the hair collection device 100 as shown in FIGS. 1-4 are for illustrative purposes only, and that many other sizes and shapes of the hair collection device 100 are well within the scope of the present disclosure. Although the dimensions of the hair collection device 100 are important design parameters for user convenience, the hair collection device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hair collection device for collecting unwanted hair when washing and rinsing hair in the shower or bath, the hair collection device comprising:
a collection member with an opening; and
a plurality of spike-like projections; and
wherein the opening allows access to an interior cavity; and
wherein the interior cavity houses the plurality of spike-like projections; and
further wherein the plurality of spike-like projections grab onto unwanted hair and retain the unwanted hair inside the collection member.

2. The hair collection device of claim 1, wherein the collection member is designed to be releasably secured to a wall of a shower or bath.

3. The hair collection device of claim 2, wherein the collection member is box-like in configuration.

4. The hair collection device of claim 3, wherein the collection member measures approximately 3 inches by 3 inches by 3 inches.

5. The hair collection device of claim 4, wherein the collection member includes a front surface, a rear surface, two opposing side surfaces, a top surface and a bottom surface.

6. The hair collection device of claim 5, wherein the collection member can be provided in numerous different colors, styles and patterns based on a user's needs or wants.

7. The hair collection device of claim 6, wherein the collection member is configured as two separate pieces.

8. The hair collection device of claim 7, wherein the two separate pieces can be secured together for use via spring clips.

9. The hair collection device of claim 7, wherein the collection member is configured as one integral piece with a large opening to access the interior cavity.

10. The hair collection device of claim 7, wherein the spike-like projections are secured within the interior cavity and around the opening.

11. The hair collection device of claim 10, wherein the spike-like projections are manufactured of silicone.

12. The hair collection device of claim 11, wherein at least one mounting member is coupled to the rear surface of the collection member.

13. The hair collection device of claim 12, wherein the at least one mounting member is a suction cup.

14. The hair collection device of claim 13, wherein the hair collection device is disposable.

15. The hair collection device of claim 13, wherein the hair collection device is reusable.

16. A hair collection device for collecting unwanted hair when washing and rinsing hair in the shower or bath, the hair collection device comprising:
a collection member in a box-like configuration with a front surface, a rear surface, two opposing side surfaces, a top surface and a bottom surface; and
a plurality of spike-like projections; and
wherein the front surface comprises an opening that allows access to an interior cavity;
wherein the interior cavity houses the plurality of spike-like projections;
wherein the plurality of spike-like projections grab onto unwanted hair and retain the unwanted hair inside the collection member; and
further wherein the collection member is designed to be releasably secured to a wall of a shower or bath via a suction cup positioned on the rear surface.

17. The hair collection device of claim 16 further comprising a plurality of indicia.

18. The hair collection device of claim 16, wherein the collection member is configured as two separate pieces.

19. The hair collection device of claim 18, wherein the two separate pieces can be secured together for use via spring clips.

20. A method of collecting unwanted hair while washing in the shower or bath, the comprising the steps of:
providing a hair collection device comprising a collection member with a suction cup positioned on the rear surface and an opening positioned on the front surface for accessing the plurality of silicone spikes;
securing the device via the suction cup to a shower or bath wall;
while showering or bathing, removing any unwanted hair from a user's fingers by inserting the unwanted hair into the opening and onto the plurality of silicone spikes; and
emptying the device as needed after showering or bathing.
